(19) United States
(12) Patent Application Publication
(10) Pub. No.: US 2010/0231290 A1
(43) Pub. Date: Sep. 16, 2010

(54) MEASUREMENT DEVICE, ELECTRONIC SYSTEM, AND CONTROL METHOD UTILIZING THE SAME

(76) Inventor: Li-Lun CHI, Hsinchu City (TW)

Correspondence Address: BIRCH STEWART KOLASCH & BIRCH, PO BOX 747, FALLS CHURCH, VA, 22040-0747, US

(21) Appl. No.: 12/404,826

(22) Filed: Mar. 16, 2009

(51) Int. Cl. G05F 1/10

(52) U.S. Cl. 327/538

(57) ABSTRACT

A measurement device independent of an integrated circuit including a transistor is disclosed. A current supply provides a first current and a second current. A switching unit transmits the first or the second current to the transistor. A current detection unit generates a first voltage and a second voltage according to a first base current of the transistor and the first current and generates a third voltage and a fourth voltage according to a second base current of the transistor and the second current. A voltage processing unit processes the first and the second voltages to generate a first differential value and processes the third and the fourth voltages to generate a second difference value. A calculation unit divides the second differential value by the first differential value to obtain a current ratio and adjusts at least one of the first and the second currents according to the current ratio.

### BACKGROUND OF THE INVENTION

1. Field of the Invention

The invention relates to a measurement device, and more particularly to a measurement device for compensating for an effect, which was caused due to shifting of a beta parameter of a transistor of an integrated circuit.

2. Description of the Related Art

With technological development, integrated circuits (ICs) are being more widely used in a variety of fields. When an IC operates, heat will be generated by the IC. If the IC is too hot, the IC will be damaged. Thus, a radiator (e.g. fan) is utilized to reduce the temperature of the IC.

To obtain the temperature of the IC, a transistor is generally designed within the IC. The voltage change of the transistor is measured to obtain the temperature of the IC. The measured voltage may be the voltage difference between the emitter and the base of the transistor. The temperature of the IC is expressed by the following equation:

$$Δ {V}_{BE} ( T ) = {V}_{BE 2} - {V}_{BE 1} = η \frac{kT}{q} ln [ \frac{{I}_{C 2}}{{I}_{C 1}} ] = η \frac{kT}{q} ln [ \frac{{I}_{E 2} \times {β}_{2} ( {β}_{1} + 1 )}{{I}_{E 1} \times {β}_{1} ( {β}_{2} + 1 )} ] .$$

As shown, the voltage of the transistor relates to the beta (β) parameter. However, the beta parameter is easily affected and shifted when the IC is manufactured. Additionally, as the IC manufacturing processes shrinks, negative effects and shifts of the beta parameter are compounded.

Meanwhile, when the transistor receives different currents, the voltage difference between the emitter and the base of the transistor will also affect band gap voltage. Thus, the beta parameter must be compensated for the effects of the band gap voltage in the band gap field. For detailed description of the band gap, reference may be made to U.S. publication No. 2007/0040600.

### BRIEF SUMMARY OF THE INVENTION

Measurement devices are provided. An exemplary embodiment of a measurement device, which is independent of an integrated circuit, comprises a transistor, comprises a current supply, a switching unit, a current detection unit, a voltage processing unit, and a calculation unit. The current supply provides a first current and a second current. The switching unit transmits the first or the second current to the transistor. The current detection unit generates a first voltage and a second voltage according to a first base current of the transistor and the first current and generates a third voltage and a fourth voltage according to a second base current of the transistor and the second current. The voltage processing unit processes the first and the second voltages to generate a first differential value and processes the third and the fourth voltages to generate a second difference value. The calculation unit divides the second differential value by the first differential value to obtain a current ratio and controls the current supply to adjust at least one of the first and the second currents according to the current ratio.

Electronic systems are also provided. An exemplary embodiment of an electronic system comprises an integrated circuit and a measurement device. The integrated circuit comprises a transistor. The measurement device is independent of the integrated circuit and comprises a current supply, a switching unit, a current detection unit, a voltage processing unit, and a calculation unit. The current supply provides a first current and a second current. The switching unit transmits the first or the second current to the transistor. The current detection unit generates a first voltage and a second voltage according to a first base current of the transistor and the first current and generates a third voltage and a fourth voltage according to a second base current of the transistor and the second current. The voltage processing unit processes the first and the second voltages to generate a first differential value and processes the third and the fourth voltages to generate a second difference value. The calculation unit divides the second differential value by the first differential value to obtain a current ratio and controls the current supply to adjust at least one of the first and the second currents according to the current ratio.

A control method for compensating for an effect, which was caused due to shifting of a beta parameter of a transistor of an integrated circuit, is provided. An exemplary embodiment the control method is described in the following. A first current and a second current are provided to the transistor. A first base current of the transistor and the first current are utilized to generate a first voltage and a second voltage and a second base current of the transistor and the second current are utilized to generate a third voltage and a fourth voltage. The first and the second voltages are processed to generate a first difference value. The third and the fourth voltages are processed to generate a second difference value. The second differential value is divided by the first differential value to obtain a current ratio. At least one of the first and the second currents is adjusted according to the current ratio.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an electronic system;

FIG. 2 shows an exemplary embodiment of the measurement device;

FIG. 3 is a flowchart of an exemplary embodiment of a control method; and

FIG. 4 is a flowchart of another exemplary embodiment of the control method.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

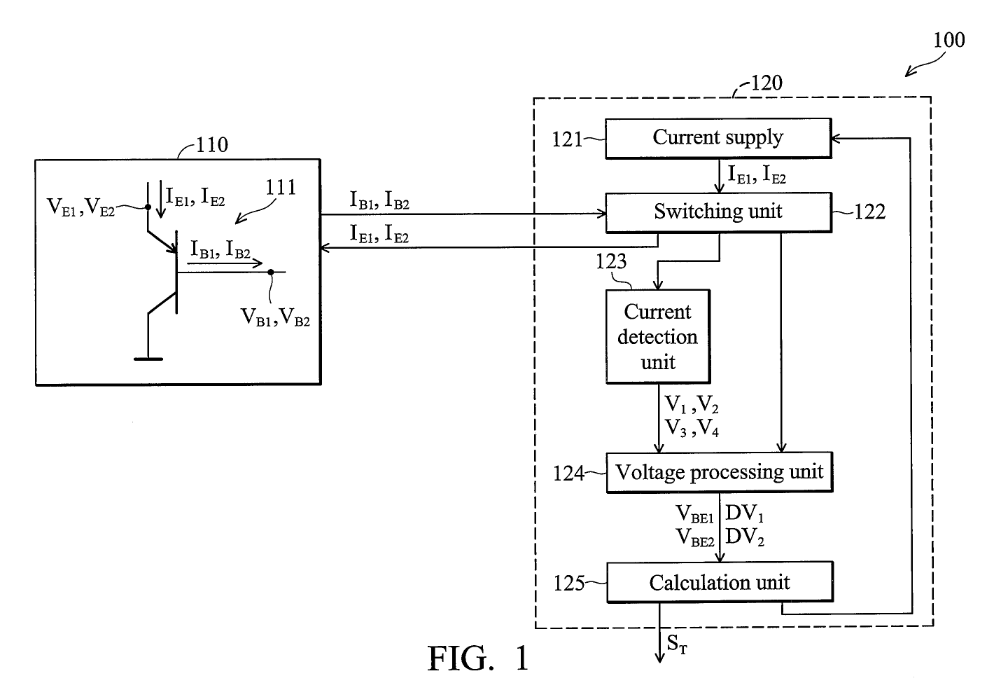

FIG. 1 is a schematic diagram of an exemplary embodiment of an electronic system. The electronic system 100 comprises an integrated circuit 110 and a measurement device 120. The integrated circuit 110 and the measurement device 120 are independent. The integrated circuit 110 comprises a transistor 111. The measurement device 120 obtains the temperature of the integrated circuit 110 according to the voltage change of the transistor 111. In this embodiment, the transistor 111 is a pnp bipolar junction transistor (BJT). The measurement device 120 comprises a current supply 121, a switching unit 122, a current detection unit 123, a voltage processing unit 124, and a calculation unit 125.

The current supply 121 provides currents I_{E1} and I_{E2}. The switching unit 122 transmits the currents I_{E1} and I_{E2} to the transistor 111. The current detection unit 123 generates voltages V₁ and V₂ according to the base current I_{B1} of the transistor 111 and the current I_{E1} and generates voltages V₃ and V₄ according to the base current I_{B2} of the transistor 111 and the current I_{E2}. Following, the voltage processing unit 124 processes the voltages V₁ and V₂ to generate a differential value DV₁ and processes the voltages V₃ and V₄ to generate a differential value DV₂. The calculation unit 125 performs a calculation, wherein the differential value DV₂ is divided by the differential value DV₁ to obtain a corresponding current ratio. The calculation unit 125 controls the current supply 121 to adjust at least one of the currents I_{E1} and I_{E2} according to the current ratio.

For example, during a first period, when the switching unit 122 transmits the current I_{E1} to the transistor 111, the base current I_{B1} of the transistor 111 is measured by the current detection unit 123. Next, the current detection unit 123 generates the voltages V₁ and V₂ according to the base current I_{B1} and the current I_{E1}. Following, the voltage processing unit 124 processes the voltages V₁ and V₂ to obtain the differential value DV₁.

During a second period, when the switching unit 122 transmits the current I_{E2} to the transistor 111, the base current I_{B2} of the transistor 111 is measured by the current detection unit 123. Next, the current detection unit 123 generates the voltages V₃ and V₄ according to the base current I_{B2} and the current I_{E2}. Following, the voltage processing unit 124 processes the voltages V₃ and V₄ to obtain the differential value DV₂. The calculation unit 125 performs a calculation, wherein the differential value DV₂ is divided by the differential value DV₁ to obtain the current ratio. The calculation unit 125 controls the current supply 121 to adjust at least one of the currents I_{E1} and I_{E2} according to the current ratio.

In one embodiment, the calculation unit 125 compares the current ratio with a preset value. When the current ratio exceeds the preset value, the calculation unit 125 controls the current supply 121 to reduce the current I_{E2}. When the current ratio is less than the preset value, the calculation unit 125 controls the current supply 121 to increase the current I_{E2}. In another embodiment, when the current ratio exceeds the preset value, the calculation unit 125 controls the current supply 121 to increase the current I_{E1}. When the current ratio is less than the preset value, the calculation unit 125 controls the current supply 121 to reduce the current I_{E1}.

Since at least one of the currents I_{E1} and I_{E2} is adjusted, the corresponding base current I_{B1} or I_{B2} is also changed. Thus, the differential value DV₁ or DV₂ is changed. For example, if the current I_{E1} is adjusted, the current detection unit 123 renews the voltage V₁. Thus, the voltage processing unit 124 also renews the differential value DV₁.

When the differential value DV₁ is changed, the calculation unit 125 renews the current ratio and compares the renewed current ratio with the preset value. The calculation unit 125 utilizes the compared result to adjust at least one of the currents I_{E1} and I_{E2} until the current ratio is equal to the preset value. When the current ratio is equal to the preset value, it represents that the effect, which was caused when the beta (β) parameter of the transistor 111 shifted, has been compensated for. Thus, the calculation 125 controls the current supply 121 to stop adjusting the currents I_{E1} and I_{E2}.

When the current ratio is equal to the preset value, the calculation unit 125 maintains the currents I_{E1} and I_{E2}. Then, the switching unit 122 transmits the maintained current I_{E1} to the transistor 111 during a third period. Following, the voltage processing unit 124 processes the emitter voltage V_{E1} and the base voltage V_{B1} of the transistor 111 to generate a base-emitter voltage V_{BE1}. In one embodiment, the base-emitter voltage V_{BE1} is a voltage difference between the emitter and the base of the transistor 111.

During a fourth period, the switching unit 122 transmits the maintained current I_{E2} to the transistor 111. Following, the voltage processing unit 124 processes the emitter voltage V_{E2} and the base voltage V_{B2} of the transistor 111 to generate a base-emitter voltage V_{BE2}. In one embodiment, the base-emitter voltage V_{BE2} is a voltage difference between the emitter and the base of the transistor 111.

The calculation unit 125 generates a temperature signal S_{T} according to the base-emitter voltages V_{BE1} and V_{BE2}. The temperature signal S_{T} represents the temperature of the integrated circuit 110. Thus, an external device (not shown) is capable of controlling a radiator (e.g. fan, now shown) according to the temperature signal S_{T} such that the temperature of the integrated circuit 110 can be reduced. In some embodiments, the control method utilized by the calculation unit 125 can be applied to a band gap circuit.

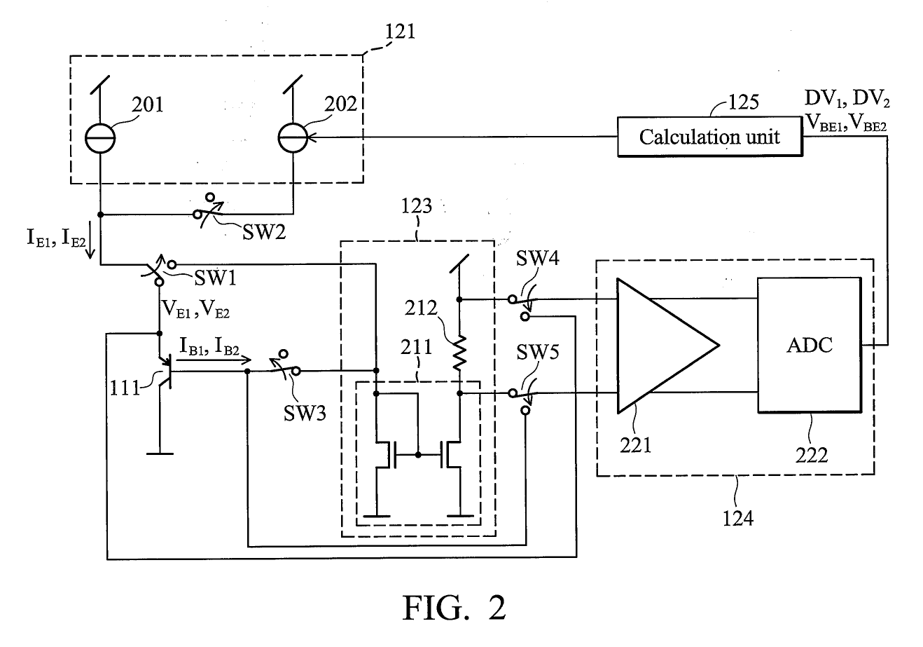

FIG. 2 shows an exemplary embodiment of the measurement device. In this embodiment, the switching unit 122 comprises a controller (not shown) and switches SW1˜SW5. The controller switches the switches SW1˜SW5 such that the switches SW1˜SW5 transmit corresponding signals.

As shown in FIG. 2, the current supply 121 comprises current sources 201 and 202. The current source 201 provides a fixed current. The current source 202 increases or reduces the current provided by the current source 201. In some embodiments, the current sources 201 and 202 are replaced by an adjustable current source.

In this embodiment, the current detection unit 123 comprises a current mirror 211 and a resistor 212. The current mirror 211 processes a current signal. The resistor 212 generates a corresponding voltage signal according to the processed current signal. The switches SW4 and SW5 transmit the voltage signal generated by the resistor 212 to the voltage processing unit 124.

For example, when the switch SW1 transmits the current I_{E1} to the transistor 111, the base current I_{B1} is generated by the transistor 111. The switch SW3 transmits the base current I_{B1} to the current mirror 211. The current mirror 211 processes the base current I_{B1}. The resistor 212 generates a voltage V₁ according to the result of processing the base current I_{B1}. The voltage processing unit 124 receives the voltage V₁ via the switches SW4 and SW5. In one embodiment, the voltage V₁=I_{B1}*R, wherein R is the resistance of the resistor 212.

Then, the switch SW3 stops transmitting the base current I_{B1} to the current mirror 211. At this time, the switch SW1 transmits the current I_{E1} to the current mirror 211. The current mirror 211 processes the current I_{E1}. The resistor generates a voltage V₂ according to the result of processing the current I_{E1}. The switches SW4 and SW5 transmit the voltage V₂ to the voltage processing unit 124. In one embodiment, the voltage V₂=I_{E1}*R. The voltage processing unit 124 generates a differential value DV₁ according to the voltages V₁ and V₂. In one embodiment, the differential value DV₁=(I_{E1}−I_{B1})*R.

Similarly, when the switch SW1 transmits the current I_{E2} to the transistor 111, the transistor 111 generates the base current I_{B2}. The switch SW3 transmits the base current I_{B2} to the current mirror 211. The current mirror 211 processes the base current I_{B2}. The resistor 212 generates a voltage V₃ according to the result of processing base current I_{B2}. The voltage processing unit 124 receives the voltage V₃ according to the switches SW4 and SW5. In one embodiment, the voltage V₃=I_{B2}*R.

Then, the switch SW3 stops transmitting the base current I_{B2} to the current mirror 211. At this time, the switch SW1 transmits the current I_{E2} to the current mirror 211. The current mirror 211 processes the current I_{E2}. The resistor 212 generates a voltage V₄ according to the result of processing the current I_{E2}. The switches SW4 and SW5 transmit the voltage V₄ to the voltage processing unit 124. In one embodiment, V₄=I_{E2}*R. The voltage processing unit 124 generates a differential value DV₂ according to the voltages V₃ and V₄. In one embodiment, the differential value DV₂=(I_{E2}−I_{B2})*R.

The calculation unit 125 performs a calculation, wherein the differential value DV₂ is divided by the differential value DV₁ to obtain a current ratio. Assuming that the differential value DV₁=(I_{E1}−I_{B1})*R and the differential value DV₂=(I_{E2}−I_{B2})*R. The current ratio Ra is expressed by the following equation:

$$Ra = \frac{( {I}_{E 2} - {I}_{B 2} ) R}{( {I}_{E 1} - {I}_{B 1} ) R} .$$

The calculation unit 125 controls the current supply 121 to adjust at least one of the currents I_{E1} and I_{E2} according to the current ratio Ra until the current ratio Ra is equal to a preset value. In one embodiment, the preset value is 16.

In this embodiment, the voltage processing unit 124 comprises a differential amplifier 221 and an analog-to-digital converter (ADC) 222. The differential amplifier 221 processes the voltages V₁ and V₂ to generate the differential value DV₁. The ADC 222 transforms the result of processing the voltages V₁ and V₂. Similarly, the differential amplifier 221 processes the voltages V₃ and V₄ to generate the differential value DV₂. The ADC 222 transforms the result of processing the voltages V₃ and V₄.

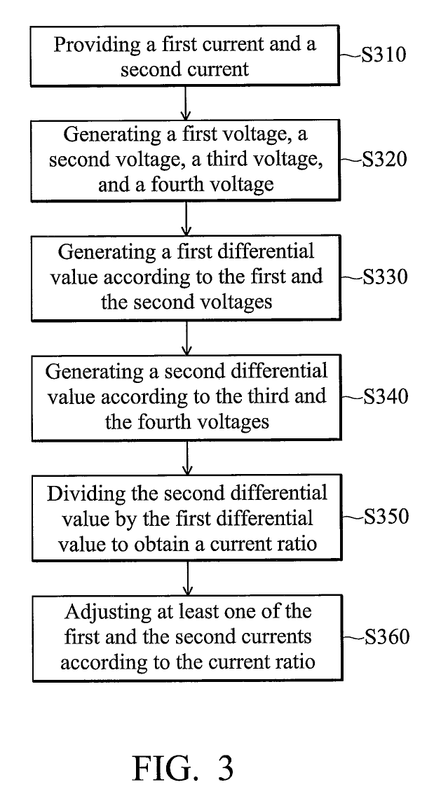

FIG. 3 is a flowchart of an exemplary embodiment of a control method. The control method shown in FIG. 3 is capable of compensating for an effect, which was caused due to shifting of the beta parameter of a transistor of an integrated circuit.

A first current and a second current are provided to the transistor (step S310). For example, the first current is provided to the transistor during a first period and the second current is provided to the transistor during a second period. In one embodiment, when the transistor receives the first current, the transistor generates a first base current. Similarly, when the transistor receives the second current, the transistor generates a second base current.

A first voltage, a second voltage, a third voltage, and a fourth voltage are generated according to a first base current of the transistor, the first current, a second base current of the transistor, and the second current (step S320). In one embodiment, a current mirror is utilized to process a current signals and a resistor is utilized to generate a corresponding voltage signal according to the result of processing the current signal. For example, the current mirror processes the first base current and the first current during the first period. Then, the resistor generates the first and the second voltages according to the result of processing the first base current and the first current. During the second period, the current mirror processes the second base current and the second current. Then, the resistor generates the third and the fourth voltages according to the result of processing the second base current and the second current.

The first and the second voltages are processed to generate a first differential value (step S330). The third and the fourth voltages are processed to generate a second differential value (step S340). In one embodiment, a differential amplifier is utilized to process the first and the second voltages. Then, an ADC is utilized to transform the result of processing the first and the second voltages. In one embodiment, the first differential value is a voltage difference between the first and the second voltages and the second differential value is a voltage difference between the third and the fourth voltages.

The second differential value is divided by the first differential value to obtain a current ratio (step S350). At least one of the first and the second currents is adjusted according to the current ratio (step S360). In one embodiment, when the current ratio exceeds a preset value, the second current is reduced. When the current ratio is less than the preset value, the second current is increased. In other embodiments, when the current ratio exceeds a preset value, the first current is increased. When the current ratio is less than the preset value, the first current is reduced.

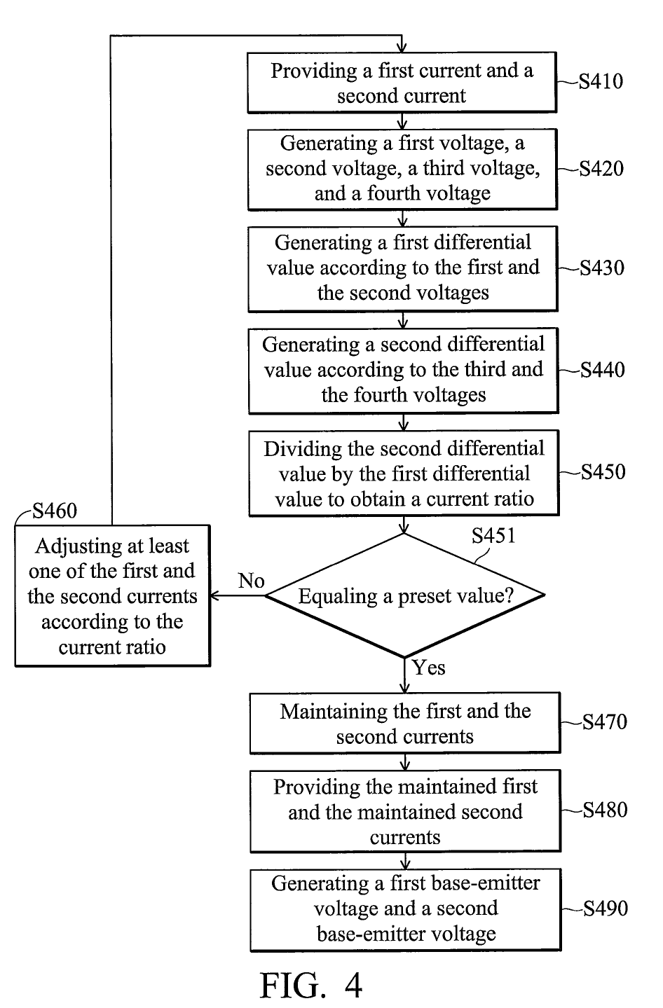

FIG. 4 is a flowchart of another exemplary embodiment of the control method. FIG. 4 is similar to FIG. 3 except for the addition of steps S451, S470, S480, and S490. Since the steps S410˜S460 and S310˜S360 have the same principle, descriptions of steps S410˜S460 are omitted for brevity.

In the step S451, it determined whether the current ratio is equal to a preset value. If the current ratio is unequal to the preset value, at least one of the first and the second currents is adjusted (step S460). Then, the adjusted current is provided to the transistor until the current ratio is equal to the preset value.

When the current ratio is equal to the preset value, the first and the second currents are maintained (step S470). Then, the maintained first current and the maintained second current are provided to the transistor (step S480). For example, the maintained second current is provided to the transistor during a third period and the maintained first current is provided to the transistor during a fourth period. When the transistor receives the first current, the transistor generates a first emitter voltage and a first base voltage. Similarly, when the transistor receives the second current, the transistor generates a second emitter voltage and a second base voltage.

A first base-emitter voltage is generated according to the first emitter voltage and the first base voltage and a second base-emitter voltage is generated according to the second emitter voltage and the second base voltage (step S490). For example, the first emitter voltage and the first base voltage are processed to generate the first base-emitter voltage during the third period and the second emitter voltage and the second base voltage are processed to generate the second base-emitter voltage during the fourth period

When the current ratio is equal to the preset value, it represents that the effect, which was caused when the beta parameter of the transistor shifted, has been compensated for. Thus, the temperature of the integrated circuit is obtained according to the change of the base-emitter voltage of the transistor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A measurement device independent of an integrated circuit comprising a transistor, comprising:
a current supply providing a first current and a second current;
a switching unit transmitting the first or the second current to the transistor;
a current detection unit generating a first voltage and a second voltage according to a first base current of the transistor and the first current and generating a third voltage and a fourth voltage according to a second base current of the transistor and the second current;
a voltage processing unit processing the first and the second voltages to generate a first differential value and processing the third and the fourth voltages to generate a second difference value; and
a calculation unit dividing the second differential value by the first differential value to obtain a current ratio and controlling the current supply to adjust at least one of the first and the second currents according to the current ratio.

2. The measurement device as claimed in claim 1, wherein during a first period, the switching unit transmits the first current to the transistor such that the transistor generates the first base current and during a second period, the switching unit transmits the second current to the transistor such that the transistor generates the second base current.

3. The measurement device as claimed in claim 2, wherein during the first period, the current detection unit measures the first base current and the first current and generates the first and the second voltage according to the result of measuring the first base current and the first current and during the second period, the current detection unit measures the second base current and the second current and generates the third and the fourth voltage according to the result of measuring the second base current and the second current.

4. The measurement device as claimed in claim 3, wherein the current detection unit comprises:
a current mirror receiving and processing the first base current and the first current during the first period and receiving and processing the second base current and the second current during the second period; and
a resistor generating the first and the second voltages according to the result of processing the first base current and the first current during the first period and generating the third and the fourth voltages according to the result of processing the second base current and the second current during the second period.

5. The measurement device as claimed in claim 3, wherein during the first period, the voltage processing unit serves the difference between the first and the second voltages as the first differential value and during the second period, the voltage processing unit serves the difference between the third and the fourth voltages as the second difference value.

6. The measurement device as claimed in claim 5, wherein the voltage processing unit comprises:
a differential amplifier processing the first and the second voltages to generate the first differential value during the first period and processing the third and the fourth voltages to generate the second differential value during the second period; and
an analog to digital converter transforming the first differential value and transmitting the transformed first differential value to the calculation unit during the first period and transforming the second differential value and transmitting the transformed second differential value to the calculation unit during the second period.

7. The measurement device as claimed in claim 1, wherein when the current ratio exceeds a preset value, the calculation unit controls the current supply to reduce the second current, and when the current ratio is less than the preset value, the calculation unit controls the current supply to increase the second current.

8. The measurement device as claimed in claim 1, wherein when the current ratio exceeds a preset value, the calculation unit controls the current supply to increase the first current, and when the current ratio is less than the preset value, the calculation unit controls the current supply to reduce the first current.

9. The measurement device as claimed in claim 1, wherein when the current ratio is equal to a preset value, the calculation unit control the current supply to maintain the first and the second currents, and the maintained first current is transmitted to the transistor during a third period, and the maintained second current is transmitted to the transistor during a fourth period.

10. The measurement device as claimed in claim 9, wherein during the third period, the voltage processing unit processes a first emitter voltage and a first base voltage of the transistor to generate a first base-emitter voltage, and during the fourth period, the voltage processing unit processes a second emitter voltage and a second base voltage of the transistor to generate a second base-emitter voltage.

11. The measurement device as claimed in claim 10, wherein the calculation unit obtains the temperature of the integrated circuit according to the first and the second base-emitter voltages.

12. An electronic system, comprising:
an integrated circuit comprising a transistor; and
a measurement device independent of the integrated circuit and comprising:
a current supply providing a first current and a second current;
a switching unit transmitting the first or the second current to the transistor;
a current detection unit generating a first voltage and a second voltage according to a first base current of the transistor and the first current and generating a third voltage and a fourth voltage according to a second base current of the transistor and the second current;
a voltage processing unit processing the first and the second voltages to generate a first differential value and processing the third and the fourth voltages to generate a second difference value; and
a calculation unit dividing the second differential value by the first differential value to obtain a current ratio and controlling the current supply to adjust at least one of the first and the second currents according to the current ratio.

13. The electronic system as claimed in claim 12, wherein during a first period, the switching unit transmits the first current to the transistor such that the transistor generates the first base current and during a second period, the switching unit transmits the second current to the transistor such that the transistor generates the second base current.

14. The electronic system as claimed in claim 13, wherein during the first period, the current detection unit measures the first base current and the first current and generates the first and the second voltage according to the result of measuring the first base current and the first current and during the second period, the current detection unit measures the second base current and the second current and generates the third and the fourth voltage according to the result of measuring the second base current and the second current.

15. The electronic system as claimed in claim 14, wherein the current detection unit comprises:
a current mirror receiving and processing the first base current and the first current during the first period and receiving and processing the second base current and the second current during the second period; and
a resistor generating the first and the second voltages according to the result of processing the first base current and the first current during the first period and generating the third and the fourth voltages according to the result of processing the second base current and the second current during the second period.

16. The electronic system as claimed in claim 14, wherein during the first period, the voltage processing unit serves the difference between the first and the second voltages as the first differential value and during the second period, the voltage processing unit serves the difference between the third and the fourth voltages as the second difference value.

17. The electronic system as claimed in claim 16, wherein the voltage processing unit comprises:
a differential amplifier processing the first and the second voltages to generate the first differential value during the first period and processing the third and the fourth voltages to generate the second differential value during the second period; and
an analog to digital converter transforming the first differential value and transmitting the transformed first differential value to the calculation unit during the first period and transforming the second differential value and transmitting the transformed second differential value to the calculation unit during the second period.

18. The electronic system as claimed in claim 12, wherein when the current ratio exceeds a preset value, the calculation unit controls the current supply to reduce the second current, and when the current ratio is less than the preset value, the calculation unit controls the current supply to increase the second current.

19. The electronic system as claimed in claim 12, wherein when the current ratio exceeds a preset value, the calculation unit controls the current supply to increase the first current, and when the current ratio is less than the preset value, the calculation unit controls the current supply to reduce the first current.

20. The electronic system as claimed in claim 12, wherein when the current ratio is equal to a preset value, the calculation unit control the current supply to maintain the first and the second currents, and the maintained first current is transmitted to the transistor during a third period, and the maintained second current is transmitted to the transistor during a fourth period.

21. The electronic system as claimed in claim 20, wherein during the third period, the voltage processing unit processes a first emitter voltage and a first base voltage of the transistor to generate a first base-emitter voltage, and during the fourth period, the voltage processing unit processes a second emitter voltage and a second base voltage of the transistor to generate a second base-emitter voltage.

22. The electronic system as claimed in claim 21, wherein the calculation unit obtains the temperature of the integrated circuit according to the first and the second base-emitter voltages.

23. A control method compensating an effect, which was caused when a beta parameter of a transistor of an integrated circuit is shifted, comprising:
providing a first current and a second current to the transistor;
utilizing a first base current of the transistor and the first current to generate a first voltage and a second voltage and utilizing a second base current of the transistor and the second current to generate a third voltage and a fourth voltage;
processing the first and the second voltages to generate a first difference value;
processing the third and the fourth voltages to generate a second difference value;
dividing the second differential value by the first differential value to obtain a current ratio; and
adjusting at least one of the first and the second currents according to the current ratio.

24. The control method as claimed in claim 23, wherein during a first period, the first current is provided to the transistor and the first base current and the first current are measured and during a second period, the second current is provided to the transistor and the second base current and the second current are measured

25. The control method as claimed in claim 24, wherein during the first period, a current mirror is utilized to process the first base current and the first current and a resistor is utilized to generate the first and the second voltages according to the result of processing the first base current and the first current, and during the second period, the current mirror is utilized to process the second base current and the second current and the resistor is utilized to generate the third and the fourth voltages according to the result of processing the second base current and the second current.

26. The control method as claimed in claim 25, wherein the first differential value is the difference between the first and the second voltages and the second differential value is the difference between the third and the fourth voltages.

27. The control method as claimed in claim 23, wherein when the current ratio exceeds a preset value, the second current is reduced, and when the current ratio is less than the preset value, the second current is increased.

28. The control method as claimed in claim 23, wherein when the current ratio exceeds a preset value, the first current is increased, and when the current ratio is less than the preset value, the first current can be reduced.

29. The control method as claimed in claim 23, wherein when the current ratio is equal to a preset value, the first and the second currents are maintained, the maintained first current is transmitted to the transistor during a third period, and the maintained second current is transmitted to the transistor during a fourth period.

30. The control method as claimed in claim 29, wherein during the third period, a first emitter voltage and a first base voltage of the transistor are processed to generate a first base-emitter voltage and during the fourth period, a second emitter voltage and a second base voltage of the transistor are processed to generate a second base-emitter voltage.

31. The control method as claimed in claim 29, wherein the temperature of the integrated circuit is obtained according to the first and the second base-emitter voltages.

32. The control method as claimed in claim 29, wherein the first and the second base-emitter voltages are utilized to generate a band gap voltage.
